(19) United States
(12) Patent Application Publication
(10) Pub. No.: US 2026/0002896 A1
(43) Pub. Date: Jan. 1, 2026

(54) SYSTEMS AND METHODS FOR FRAME CONTROL IN TEXTURE ANALYSIS

(71) Applicant: Edax LLC, Warrendale, PA (US)

(72) Inventors: William Carl LENTHE, Glenshaw, PA (US); Stuart Ian WRIGHT, St. George, UT (US)

(21) Appl. No.: 19/256,954

(22) Filed: Jul. 1, 2025

Related U.S. Application Data
(60) Provisional application No. 63/666,549, filed on Jul. 1, 2024.

(51) Int. Cl. G01N 23/2055; G01N 23/203; G01N 23/2251

(52) U.S. Cl. CPC G01N 23/2055; G01N 23/203; G01N 23/2251; G01N 2223/053; G01N 2223/418; G01N 2223/606

(57) ABSTRACT

A system may obtain a plurality of experimental diffraction patterns. A system may identify a crystallographic orientation of each diffraction pattern of the plurality of experimental diffraction patterns. A system may build one or more pole figures. A system may select a reference spherical function having a reference frame. A system may correlate spherical images from the pole figures and the reference spherical function. A system may determine a sample frame of the crystallographic orientations. A system may rotate the crystallographic orientations of the plurality of experimental diffraction patterns into alignment with the reference frame to produce a plurality of rotated crystallographic orientations.

### PRIORITY

The present application claims priority to and the benefit of U.S. PROVISIONAL PATENT APPLICATION No. 63/666,549 filed Jul. 1, 2024 and titled SYSTEMS AND METHODS FOR FRAME CONTROL IN TEXTURE ANALYSIS, the disclosure of which is incorporated herein by reference in its entirety.

### BACKGROUND OF THE DISCLOSURE

Electron Backscatter Diffraction (“EBSD”) and transmission Kikuchi diffraction (“TKD”) have grown into a robust analytic technique for the measurement of material properties. EBSD is an analytical technique performed in a scanning electron microscope (“SEM”) in a low pressure or near vacuum environment. TKD is an analytical technique performed in a transmission microscope environment in a low pressure or near vacuum environment. A sample is positioned beneath a column housing an electron source. The electron source may be any suitable source, such as a tungsten filament, thermal field emission, or LaB6 electron source. The electron source may emit electrons that are directed in a beam through the column and toward a sample chamber. The sample chamber may be connected to the column and allow a sample to be held in line with the electron beam for imaging. The sample may have a prepared surface that is substantially flat and free of deformation from the preparation (i.e., polishing).

As shown in FIG. 1, conventional EBSD may be conducted in an SEM 100 by presenting a sample 102 at an angle 104 to an electron beam 106. The angle 104 may be any angle within a range of values from 1° to 50° degrees and most commonly, 20° to the beam. The position of the sample 102 relative to the beam 106 may be achieved by tilted a sample stage 108 approximately 70° from level or by providing a sample holder (not shown) having non-parallel surfaces mounted to the sample stage 108 or a combination of the two. The angle 104 of the sample 102 relative to the beam 106 allows electrons from the beam 106 to enter a portion of the sample 102. In the portion of the sample, known as the interaction volume, electrons diffract from crystal planes inside the sample 102. The electrons travel from the interaction volume toward a detector 110 in a geometric pattern of relative intensities of diffracted electrons 112. The diffracted electrons 112 may be measured to calculate the relationship of crystal planes within the interaction volume and, therefore, an orientation of the crystal planes in space relative to the sample surface or other prescribed reference frame.

Lenses 114, such as electromagnetic lenses, may focus and/or deflect the electron beam 106 at different working distances (focal length beneath a lowest point of the column 116) and/or locations on the sample 102. A “scan” of the SEM 100 may include construction of an image of a surface of the sample 102 by rastering the beam 106 through a predetermined range of positions and/or deflections of the beam 106. A combination of the EBSD detector 110 and rastering of the beam 106 allow for the construction of orientation maps of a portion of the sample 102. An orientation map may allow for the measurement of grain size and shape, plastic deformation, orientation distribution, texture measurements, phase relationships, transformations, grain boundary relationships, and other properties. Additionally, the orientation map may allow visualization of the spatial relationship of the measurements. While at least partially dependent on the SEM and settings (e.g., accelerating voltage, beam current, pressure in the chamber, etc.) used, ESBD in an SEM may allow for grain resolution down to 20 nm or less on bulk samples.

Collection rates for individual diffraction patterns may range from 2 seconds per pattern to well over 6000 patterns per second. The collection rate of the EBSD detector 110 may depend at least partially upon the settings of the SEM 100 and the settings and/or specifications of the EBSD detector 110. The collection rate of the EBSD detector 110 may also depend at least partially upon the sample from which orientations are measured. The diffraction volume may produce less than ideal diffraction patterns due to a number of factors, including poor surface preparation, fine grain size, deformation, hydrocarbon contamination, oxide surface layers, or combinations thereof. For example, a longer dwell time may be necessary to achieve satisfactory contrast in the collected diffraction pattern or a sufficient signal to noise ratio to measure and calculate an orientation of the sample 102 where the beam 106 meets the sample 102. In many laboratories, instrument time is a priority, therefore increasing collection speed and increasing high confidence orientation measurement rates on a variety of sample types may be desirable.

### SUMMARY

In some aspects, the techniques described herein relate to a method for characterizing a material, the method including: obtaining a plurality of experimental diffraction patterns; identifying a crystallographic orientation of each diffraction pattern of the plurality of experimental diffraction patterns; building one or more pole figures; selecting a reference spherical function having a reference frame; correlating spherical images from the pole figures and the reference spherical function; determining a sample frame of the crystallographic orientations; and rotating the crystallographic orientations of the plurality of experimental diffraction patterns into alignment with the reference frame to produce a plurality of rotated crystallographic orientations.

In some aspects, the techniques described herein relate to a method of characterizing a material, the method including: obtaining a plurality of experimental diffraction patterns; identifying a crystallographic orientation of each diffraction pattern of the plurality of experimental diffraction patterns; building one or more pole figures; determining symmetry group of the plurality of experimental diffraction patterns; selecting a reference spherical function having a reference frame based at least partially on the symmetry group; correlating spherical images from the pole figures and the reference spherical function; determining a sample frame of the crystallographic orientations relative to the reference frame; and rotating the crystallographic orientations of the plurality of experimental diffraction patterns into alignment with the reference frame to produce a plurality of rotated crystallographic orientations.

In some aspects, the techniques described herein relate to a system for characterizing a material, the system including: an electron microscope including an electron source configured to produce electrons; a detector configured to receive diffracted electrons produced by the electron source; and a computing system in data communication with the detector, the computing system including: a processor, and memory having instructions stored thereon that, when executed by the processor, cause the computing system to: obtain a plurality of experimental diffraction patterns, identify a crystallographic orientation of each diffraction pattern of the plurality of experimental diffraction patterns, build one or more pole figures; select a reference spherical function having a reference frame; correlate spherical images from the pole figures and the reference spherical function; determine a sample frame of the crystallographic orientations, and rotate the crystallographic orientations of the plurality of experimental diffraction patterns into alignment with the reference frame to produce a plurality of rotated crystallographic orientations.

This summary is provided to introduce a selection of concepts that are further described below in the detailed description. This summary is not intended to identify specific features of the claimed subject matter, nor is it intended to be used as an aid in limiting the scope of the claimed subject matter.

Additional features of embodiments of the disclosure will be set forth in the description which follows. The features of such embodiments may be realized by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 depicts an embodiment of conventional electron backscatter diffraction (“EBSD”) pattern collection in a scanning electron microscope (“SEM”).

FIG. 2 depicts an embodiment of a Kikuchi-sphere.

FIG. 3 is a flowchart illustrating a method of characterizing a material, according to at least some embodiments of the present disclosure.

FIG. 4 is a comparison of binning techniques for binning the dataset of crystallographic orientations.

FIG. 5 is an illustration of an embodiment of Square Lambert binning of the dataset of crystallographic orientations illustrated in FIG. 4.

FIG. 6 is a comparison of Spherical Harmonic Transform smoothing of a discrete pole figure or binned data and a Bunge Harmonic expansion for texture analysis.

FIG. 7 is an embodiment of a symmetry descriptors for each primary direction in a dataset of crystallographic orientations represented by the pole figures for a cubic point group.

FIG. 8 is a comparison of a composite symmetry descriptor created by a combination of the symmetry descriptors of FIG. 7 to a target symmetry descriptor for the identified symmetry group.

FIG. 9 is an embodiment of a series of rotations for automatic texture alignment of crystallographic orientations smoothed by a SHT in a sample frame with a reference frame of a known texture based on the composite symmetry alignment.

FIG. 10 is an embodiment of a discrete pole figures illustrating automated texture alignment to a reference frame.

FIG. 11 is an example of enforcing orthorhombic symmetry on the set of crystallographic orientations of FIG. 10.

FIG. 12 is an embodiment of pole figures for a hexagonal titanium sample and the associated automated texture alignment of the pole figures.

FIG. 13 is an embodiment of the parent grain pole figure for the cubic parent grain reconstruction of the titanium of FIG. 12 at a high temperature of deposition during additive manufacturing.

FIG. 14 is a schematic illustration of a computing system on which any method or portion of a method may be executed.

### DETAILED DESCRIPTION

One or more specific embodiments of the present disclosure will be described below. In an effort to provide a concise description of these embodiments, some features of an actual embodiment may be described in the specification. It should be appreciated that in the development of any such actual embodiment, as in any engineering or design project, numerous embodiment-specific decisions will be made to achieve the developers' specific goals, such as compliance with system-related and business-related constraints, which may vary from one embodiment to another. It should further be appreciated that such a development effort might be complex and time consuming, but would nevertheless be a routine undertaking of design, fabrication, and manufacture for those of ordinary skill having the benefit of this disclosure.

An electron backscatter diffraction (“EBSD”) detector may collect a diffraction pattern using an image generation surface and an image collection device. For example, an image collection device, such as a Complementary Metal-Oxide-Semiconductor (CMOS) sensor, may be positioned near an end of the EBSD detector proximate a crystalline sample in a scanning electron microscope (“SEM”). The image collection device may be situated behind (i.e., farther from the sample) an image generation surface. The image generation surface may generate a signal and/or image visible to the image collection device based on the presence of electrons at or near the image generation surface. For example, a scintillator may receive incident electrons and re-emit light. The light may be collectable by the image collection device. In another example, direct electron detection may be used to generate and/or collect a diffraction pattern image without the generation of light by the image generation surface. Electrons from an electron beam may be diffracted toward the image generation surface by a plurality of crystal planes in the prepared sample. The repeating crystal planes of the sample may diffract the electrons in an array of geometrically related “bands” of electrons. The electron bands may strike the image generation surface and may be collected by the image collection device.

The electron beam may interact with the crystal lattice of the sample at the surface and in a subsurface interaction volume. A crystal orientation of the crystal lattice may be calculated from the resulting diffracted electrons. A diffraction pattern comprising a plurality of electron bands may be measured and an orientation calculated based on known crystal structure parameters for the sampled crystal lattice and the relative location of detected electron bands in the pattern. In some samples, the quality of the diffraction may be less than desired. For example, the signal-to-noise ratio of the electron bands, the contrast in the image, or other image quality degradation may compromise accurate detection of electron bands within the diffraction pattern.

Texture is a measurement of the crystallographic orientation of a polycrystalline sample. In particular, the texture is a measurement of the degree to which the otherwise random orientations align in the sample material. For example, in a polycrystalline material that is free of external influences or effects, most materials will crystallize from a molten or non-crystalline state into a plurality of crystals or grains with random orientations. External influences can cause crystallization in a preferred orientation or, after crystallization, work the polycrystalline structure into a preferred orientation. Different external influences, such as rolling, wire drawing, degree of recrystallization, parent grain recrystallization, or deposition methodology may produce different textures or strengths of a texture. In such examples, a crystal structure of a particular crystal symmetry (such as cubic or hexagonal) will exhibit different characteristic textures. More crystals and/or a larger proportion of volume of the sample with same orientation will exhibit a stronger texture. The strength of the texture may be used to determine bulk material properties, including wear patterns, recrystallization effects, electrical conductivity, and other desirable or undesirable properties.

Texture measurements are made relative to a reference frame, for example a processing direction of the sample. For example, the processing direction may be a rolling direction, a normal direction, a draw direction, a thermal gradient direction, or other predominant direction of the processing technique applied to the sample to manipulate the crystal structure. In a rolled metal sample, such as rolled steel, the processing direction may be the rolling direction, with orientation measurements conventionally measured in a compression direction that is perpendicular to the rolling direction. In drawn rod or wire example, the processing direction may be the draw direction, with the orientation measurements taken in a transverse cross-sectional plane that is perpendicular to the draw direction.

However, the sample taken or provided for analysis may be taken from the processed piece with a sample orientation of the sample surface that is different from the processing direction or a conventional measurement direction. In some embodiments, the sample may be collected or provided with no recorded processing direction. In some embodiments, the sample may be prepared for measurements at an unknown orientation relative to the processing direction. In some cases, the processing may be complex, and the processing directions and reference frames are not fully understood such as in processing to produce nano-structure microstructures via severe plastic deformation, e.g., friction stir processing, accumulated roll bonding or equal channel extrusion.

Texture analysis allows a user to evaluate the strength of the measured texture from the sample against an expected or known texture for the sample. In some embodiments, however, the orientation of the sample frame from which the measurements are made may be different from and/or oriented at an angle to the expected reference frame based on a processing direction. In some embodiments, such as a microstructure that exhibits parent grain recrystallization, a measurable texture in a region of the sample may develop independently of a sample frame and/or in the absence of a processing direction. For example, manufacturing of some metals may span a large temperature range, causing changes in crystallographic structure that mask the orientation of the parent grain at a higher temperature.

In some embodiments, systems and methods according to the present disclosure allow for the inline- or post-processing of electron diffraction patterns and orientation data to identify and correct for misalignments of a sample frame and an expected reference frame for a given or known texture. In some embodiments, systems and methods according to the present disclosure allow for the inline- or post-processing of electron diffraction patterns and orientation data to identify an unknown symmetry and texture, and subsequently correct for misalignments of a sample frame and an identified reference frame for the detected texture.

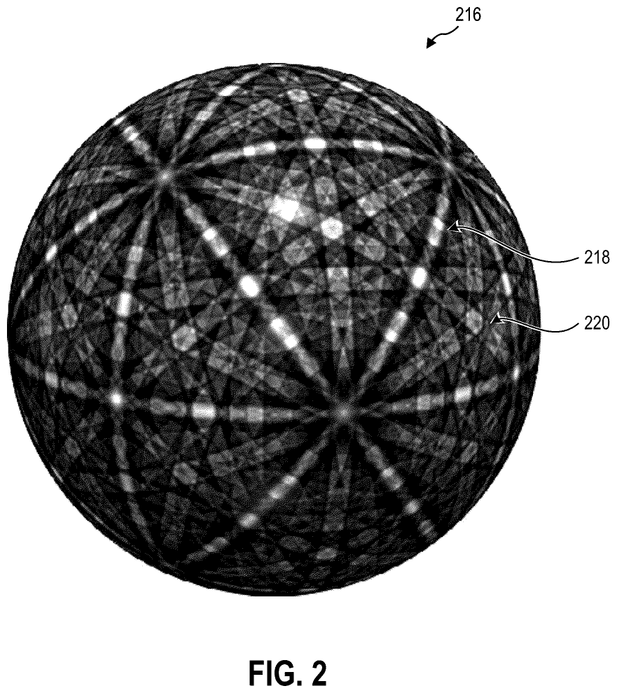

FIG. 2 depicts an embodiment of a Kikuchi-sphere 216. The K-sphere 216 is a representation of electron diffraction from a crystal lattice including a plurality of repeating planes. The K-sphere 216 may exhibit areas of high electron concentration and areas of lower electron concentration. The high electron concentration may manifest as a brighter electron band 218 and the lower electron concentration may manifest as darker region 220 between the electron bands 218. As described herein, “brighter” and “darker” should be understood to refer to the relative appearance of the electron concentrations after interaction with an image generation surface, such as a phosphor scintillator. The brighter and darker regions correspond to the intensity of the electron concentration due to the constructive and deconstructive interference of the electrons diffracting from the crystal lattice of the sample.

The electron bands 218 may exhibit a higher concentration of electrons due to the diffraction of electrons from the repeating crystal planes of a crystal lattice. The repeating crystal planes may diffract incident electrons from an electron beam toward an EBSD detector. The diffraction may create regions of higher and lower electron intensity due, at least partially, to constructive and deconstructive interference of the electrons having different paths lengths relative to the lattice parameters. The darker regions 220 may exhibit some electron interactions due to electrons scattered toward the EBSD detector without exhibiting diffraction.

Dictionary indexing may allow for the indexing of lower-quality collected diffraction patterns. For example, Hough indexing is an inverse model solution that transforms the electron bands of the collected diffraction pattern to a point within a 2-dimensional coordinate space with intensity values (visualized as greyscale values) in the transform to locate the relative position of the diffraction bands. However, the reliability of the Hough transform from the collected pattern are limited by the quality of the diffraction pattern, which can degrade during data collection from a sample due to detector settings, microscope settings, sample conditions, vacuum condition in the microscope, or other considerations.

Dictionary indexing is a forward model indexing methodology that relies upon a pre-determined master pattern of a K-sphere to generate an array (dictionary) of patterns at various crystal orientations. With a dictionary of patterns generated at known orientations, the system can compare a collected diffraction pattern to the dictionary to determine a closest match. The accuracy and/or precision of the closest match is based at least partially on the angular displacement between each known orientation. For example, a dictionary of patterns at known orientations with 1° between each orientation may provide more accurate and/or more precise matches than a dictionary with 3° between each known orientation. Other forward model indexing techniques include spherical harmonic transform (SHT) indexing and refinement of a prior indexing result.

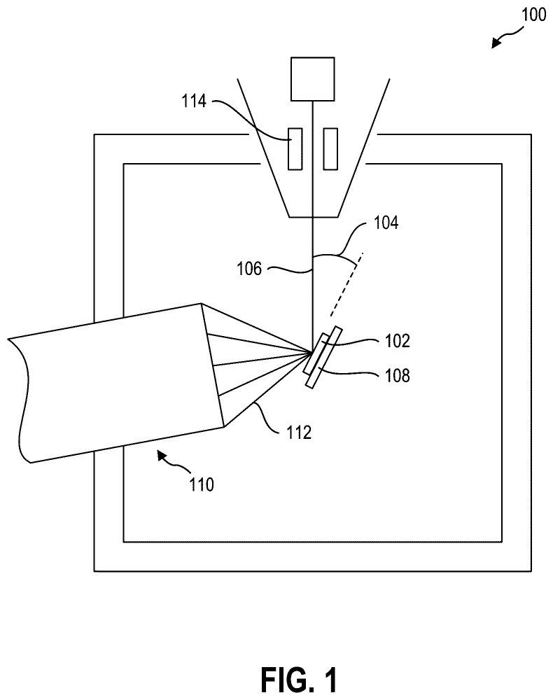

In some embodiments, the system collects a diffraction pattern from a sample and indexes the collected diffraction pattern as described in relation to FIG. 1. As used herein, “indexing” should be understood to refer to the calculation of one or more crystal orientations at which the sampled portion of the crystal lattice may be oriented relative to a surface of the sample. In some embodiments, the orientation of the crystal lattice may be calculated relative to another reference frame. For example, a user may desire the orientation to be calculated relative to a transverse axis of the sample surface, such as when evaluating texture and the processing direction of the sample is known.

Indexing a diffraction pattern may include detecting at least three electron bands in a diffraction pattern, such as the averaged diffraction pattern, selecting a plurality of sets of three electron bands (“a triplet”) from the at least three electron bands, and calculating a one or more crystallographic orientations for each triplet based on known lattice parameters. For example, a diffraction pattern having five detected electron bands may have ten triplets. A single triplet may provide a plurality of crystallographic orientations. Indexing a diffraction pattern may include determining the orientation calculated most frequently based on the plurality of triplets.

A confidence index may be calculated during indexing. The confidence index may be a weighted ratio of the most likely orientation and a second-most likely orientation. A crystal lattice may exhibit various forms of symmetry. The symmetry of the crystal lattice may manifest as symmetry in the diffraction pattern. Symmetry in the diffraction pattern may lead a single triplet to provide multiple possible orientations of a crystal lattice that may correspond to the measured triplet. Therefore, a single triplet alone may lead to ambiguity and/or “false positives.” However, taken in aggregate, multiple triplets may align with a one orientation more often than a second orientation. A confidence index may reflect the rate at which a “correct” orientation is calculated to match the detected triplets versus a “false positive.” A confidence index may be calculated by

CI=(V₁−V₂)/V_{Ideal} (1)

where CI is the confidence index; V₁ and V₂ are the number of triplets that may correspond to the most likely orientation and the second-most likely orientation, respectively; and V_{Ideal} is the total possible number of triplets that may correspond to an orientation (i.e., the total number of detected triplets). The confidence index may allow a user to determine the level of ambiguity in a system exhibiting symmetry.

As the system directs the electron beam at various sampling locations on the sample, the electron beam interacts with different crystal lattices. The resulting electron diffraction patterns are indexed to determine a crystallographic orientation at the sampling location and of the diffraction pattern. In some embodiments, the diffraction pattern is saved to a hardware storage device for later indexing. In some embodiments, the diffraction pattern and a determined crystallographic orientation is saved to a hardware storage device. In some embodiments, the determined crystallographic orientation is saved to a hardware storage device and the diffraction pattern is discarded.

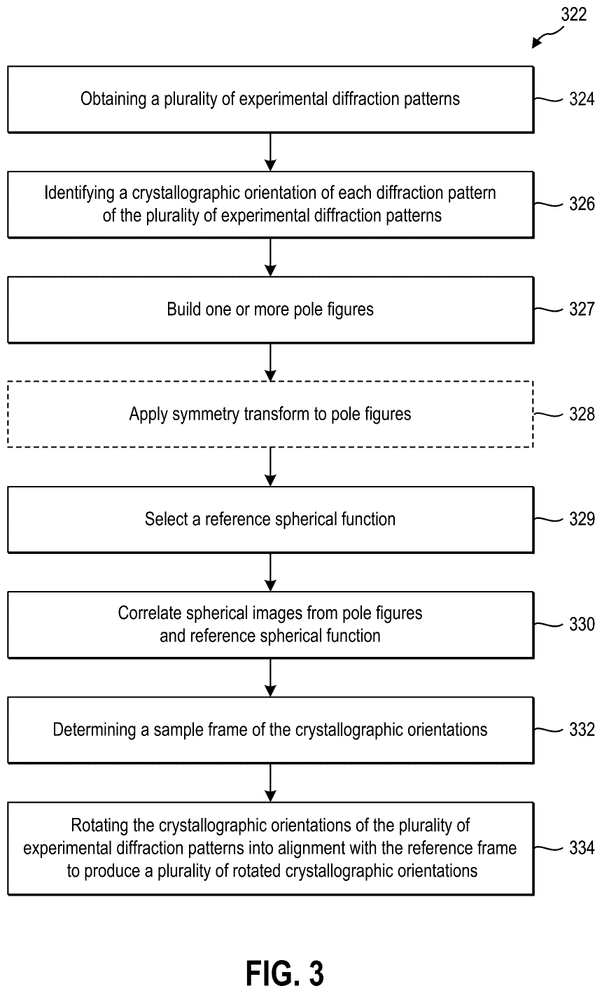

FIG. 3 is a flowchart illustrating a method of characterizing a material, according to at least some embodiments of the present disclosure. The techniques described in relation to the embodiments of FIG. 3 are described in more detail below.

In some embodiments, the method 322 includes obtaining a plurality of experimental diffraction patterns, such as representative of the Kikuchi bands described in relation to FIG. 2, at 324. In some embodiments, the plurality of diffraction patterns is obtained live and in real time from a detector and electron microscope, such as described in relation to FIG. 1. In some embodiments, the plurality of diffraction patterns are obtained via EBSD. In some embodiments, the plurality of diffraction patterns are obtained via TKD. In some embodiments, obtaining the plurality of diffraction patterns includes accessing or receiving stored images of the plurality of diffraction patterns from a prior data collection via EBSD or TKD. In some embodiments, obtaining the plurality of diffraction patterns includes accessing or receiving stored band locations and orientations representative of collected diffraction patterns via EBSD or TKD.

The method 322 further includes identifying a crystallographic orientation of each diffraction pattern of the plurality of experimental diffraction patterns at 326. In some embodiments, identifying a crystallographic orientation includes forward-model indexing, such as dictionary indexing. For example, a dictionary of patterns (experimental or simulated) at known crystallographic orientations may be compared against the experimental diffraction pattern to determine the crystallographic orientation of the experimental diffraction pattern. In some embodiments, identifying a crystallographic orientation includes inverse-model indexing, such as via a Hough transform to detect band locations. For example, the inverse-model indexing may detect the location of the detected bands and fit the bands to the crystallographic structure to determine the crystallographic orientation.

The method 322, in some embodiments, further includes building one or more pole figures (PFs) from the crystallographic orientations at 327. In some embodiments, the building of the PFs includes orienting the PF relative to any direction in the crystal frame that has a symmetry operator. In some embodiments, building of the PFs includes orienting the PF relative to any other direction with multiplicity less than the full group order. In some embodiments, the building of the PFs includes orienting the PF relative to a processing direction or a direction relevant to the processing, such as slip system normal. In some embodiments, the building of the PFs includes orienting the PF relative to low index directions.

In some embodiments, the PF exhibits areas of high occurrences of crystallographic orientations. The peaks are the regions of the PF in which the highest density (or greatest frequency) of measured crystallographic orientations appear. For example, a dataset including crystallographic orientation from a completely randomly distributed polycrystalline sample would produce a PF with a uniform frequency of crystallographic orientations. Such an example produces a uniform PF with no texture peaks. In contrast, a monocrystalline sample with only one measurable crystallographic orientation will exhibit a very high concentration of measurements at a single orientation.

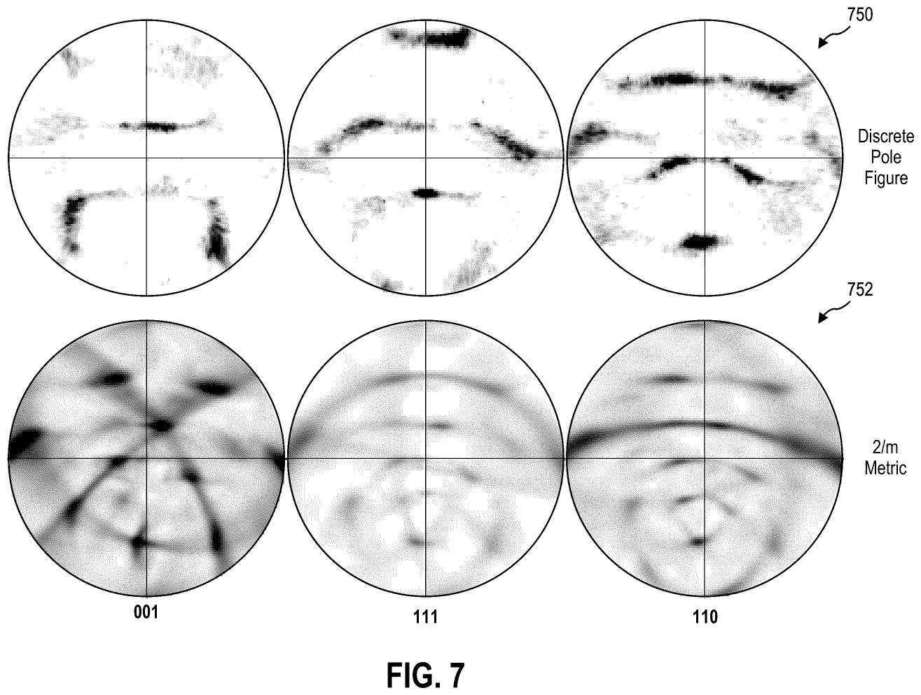

In some embodiments, the method 322 optionally includes applying a symmetry transform in the dataset of crystallographic orientations at 328. For example, the presence of an crystal direction with a known orientation can indicate the presence of other crystal directions and/or symmetrically equivalent crystal directions. As will be discussed in more detail herein at least in relation to FIG. 7, enforcing orthorhombic symmetry (or other symmetries, such as transverse isotropy) in the crystallographic orientations and/or PF can improve the data quality and/or statistics quality. Such symmetry can be enforced on the dataset before or after smoothing and/or binning of the dataset.

In some embodiments, the method 322 includes selecting a reference spherical function at 329. For example, selecting a reference spherical function may include obtaining an input texture at a reference frame. For example, the input texture may be received as an idealized texture with peaks or other areas of high orientation frequency according to an expected texture. In some embodiments, the reference spherical function is the known or expected texture for the sample. For example, the reference spherical function may be received from a user input. In some examples, the reference spherical function may be a measured PF or derivative thereof from another region of the sample. In some examples, the reference spherical function may be a measured PF or derivative thereof from another sample. In some examples, the reference spherical function may be a measured PF or derivative thereof from another sample or another region of the sample that has been transformed through a rotation, symmetry function, or other transformation. In some embodiments, the reference spherical function is determined at least partially automatically by detection and/or construction of locations of symmetry operators in the PF, as will be described in more detail herein.

In some embodiments, the method 322 further includes correlating the spherical images from the PFs (and/or PF with a symmetry transform applied thereto) to the selected reference spherical function at 330. In some embodiments, the correlation and/or comparison is performed in frequency space with a spherical harmonic transform. In some embodiments, the correlation and/or comparison is performed in real space.

In some embodiments, the method 322 includes determining a sample frame of the crystallographic orientations at 332. The sample frame is the orientation of the sample in space relative to the expected reference frame of the input texture. For example, the input texture for a drawn wire texture of a sample with a cubic crystal structure has a preferred [001] orientation in the z-direction in a conventional reference frame for the texture analysis. In some embodiments, a texture peak of the [001] orientation measured from a sample may be offset from the z-direction, indicating a sample frame that is different from the reference frame of the input texture.

In some embodiments, determining a sample frame includes determining an offset from the reference frame that includes an axis direction and rotation about the axis. For example, the axis direction may be a crystallographic direction of the crystal structure of the sample, such as a [181] direction. The rotation around the axis rotates the measured crystallographic orientations of the sample frame to the expected reference frame. In some embodiments, determining the sample frame includes determining a series of rotations around each of the orthogonal directions of the PF to align the crystallographic orientations of the sample frame to the expected reference frame. For example, the sample frame may be defined by a series of rotations around the x-axis, y-axis, and z-axis of the PF. In some embodiments, the sample frame orientation relative to an expected reference frame orientation is determined based at least partially on an angular displacement of a composite symmetry descriptor relative to a target symmetry descriptor for a known crystal structure.

In some embodiments, the method 322 further includes rotating the crystallographic orientations of the plurality of experimental diffraction patterns into alignment with the reference frame to produce a plurality of rotated crystallographic orientations at 334. The resulting aligned dataset allows for simpler texture evaluation and comparison between samples by comparing distribution of measured crystallographic orientations and/or strength of the texture between sampling regions within a sample or between different samples of the same material.

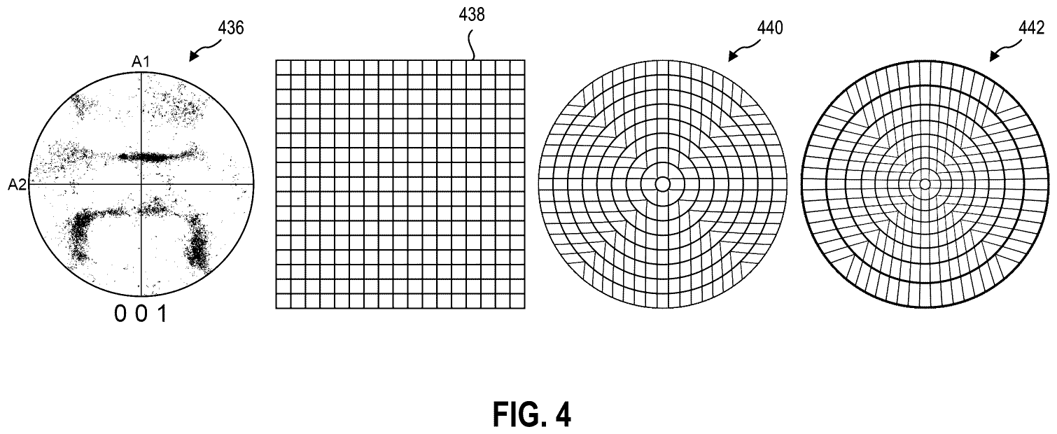

FIG. 4 is a comparison of binning techniques for binning the dataset of crystallographic orientations. In some embodiments, binning the dataset of measured crystallographic orientations includes plotting a precise location of each measured crystallographic orientations on a PF 436. A discrete PF illustrates the distribution of measured crystallographic orientations from a dataset relative to the sample frame. The discrete PF 436 represents the crystallographic orientations of the experimental diffraction patterns, such as those obtained in relation to FIG. 3.

Binning a dataset includes determining the quantity of datapoints within a plurality of discrete bins of the orientation space represented by the PF 436. In some embodiments, binning the dataset of crystallographic orientations includes using an equal area binning methodology in which each bin of the equal area grid represents an equal area portion of the orientation space. For example, the equal area grid may include a square representation of the orientation space, such as Square Lambert binning 438. In some examples, the equal area grid may include a circular representation of the orientation space, such as Lambert azimuthal binning 440. In some embodiments, the binning is a conformal binning or other non-area preserving projection, such as stereographic binning 442.

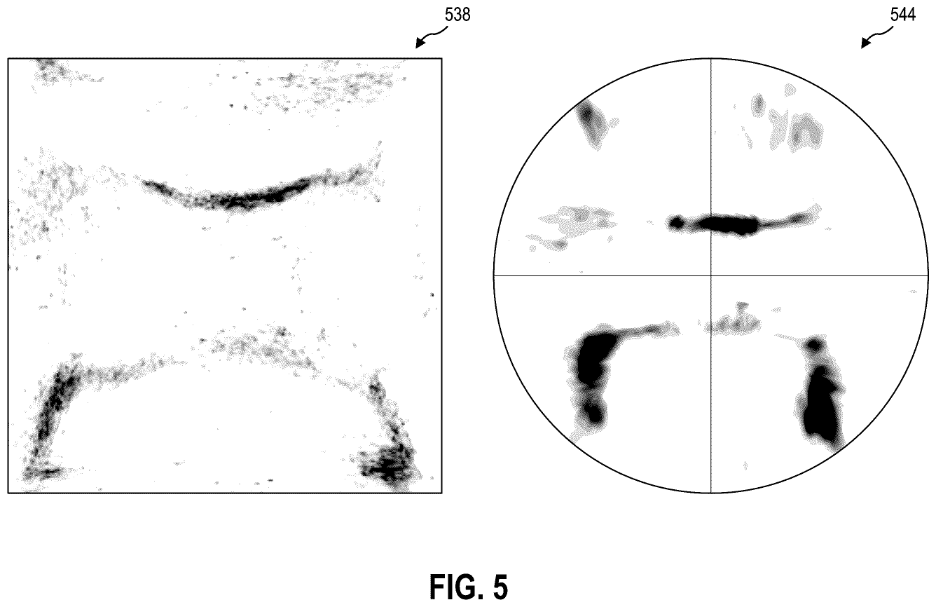

FIG. 5 is an illustration of an embodiment of Square Lambert binning 538 of the dataset of crystallographic orientations illustrated in FIG. 4. The binning of the crystallographic orientation of the discrete PF 436 of FIG. 4 with the Square Lamber binning 538 produces binned data 544 that includes a quantity of measured crystallographic orientations in each bin. The binned data 544 allows for a more computational-resource-efficient technique for representing the density and/or frequency of crystallographic orientations in the dataset, allowing the relative quantities of crystallographic orientations to be smoothed and calculate the texture intensity and/or texture peak height.

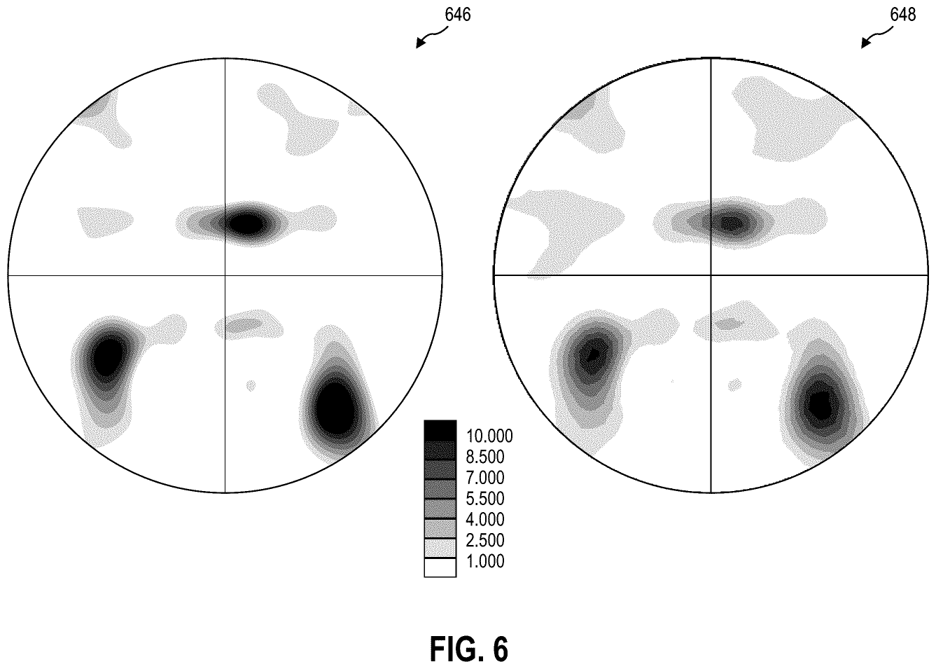

FIG. 6 is a comparison of Spherical Harmonic Transform (SHT) smoothing 646 of a discrete PF (such as the discrete PF 436 described in relation to FIG. 4) or binned data (such as the binned data 544 described in relation to FIG. 5) and a Bunge Harmonic expansion 648 for texture analysis. A SHT is a spherical analog to a Fourier transform, approximating a curve in a spherical coordinate system. The SHT further reduces computational resources needed to describe the dataset of crystallographic orientations and the associated texture strength. In some embodiments, the discrete PF and/or the binned data may be smoothed through other functions, such as the Bunge Harmonic expansion 648 illustrated in FIG. 6. In some embodiments, the Bunge Harmonic expansion requires greater computation resources than the SHT.

FIG. 7 is an embodiment of a symmetry descriptors 752 for each primary direction in a dataset of crystallographic orientations represented by the PFs 750 for a cubic point group. 2/m symmetry is a two-fold symmetry around a central mirror plane. The 2/m symmetry descriptor 752 for each of the lowest order crystal directions (e.g., [001], [111], [110]) or other directions, as described in relation to FIG. 3, are calculated based on the measured crystallographic orientations of the dataset (illustrated in the discrete PFs 750).

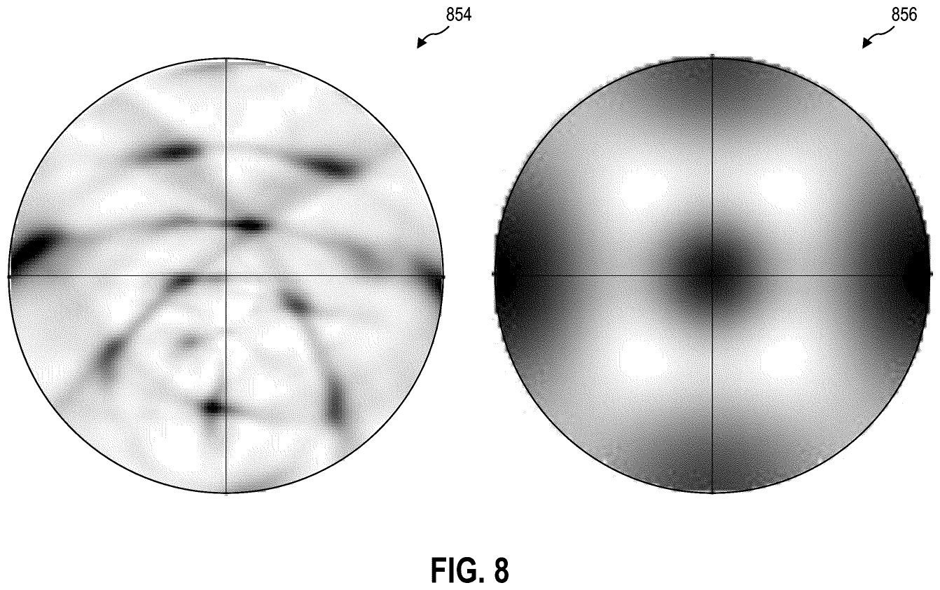

FIG. 8 is a comparison of a composite symmetry descriptor 854 created by a combination of the symmetry descriptors 752 of FIG. 7 to a target symmetry descriptor 856 for the identified symmetry group. In some embodiments, the composite symmetry descriptor 854 is created summing the values of the individual symmetry descriptors 752 of the primary crystal directions to describe the expected observed symmetry of the structure. In some embodiments, the composite symmetry descriptor 854 is created by a weighted sum of the values of the individual symmetry descriptors 752 of the primary crystal directions to describe the expected observed symmetry of the structure.

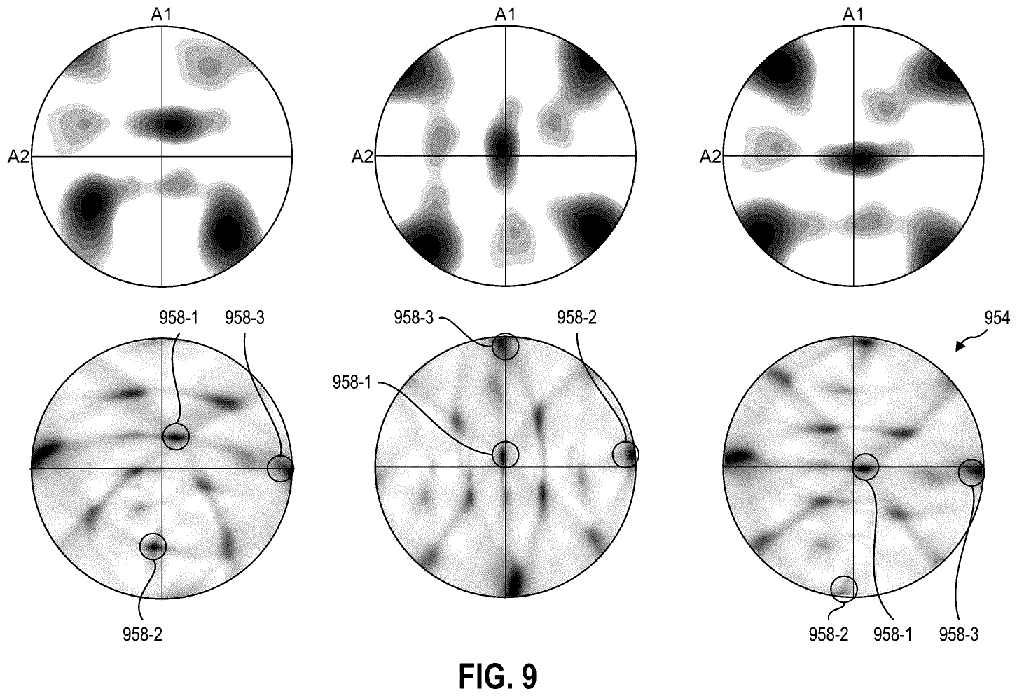

The target symmetry descriptor 856 is representative of the expected symmetry descriptor for sample. In some examples, the expected symmetry descriptor for the sample is orthorhombic due, in at least part, to the processing of the sample itself, regardless of the underlying crystal symmetry. By aligning the composite symmetry descriptor 854 with the target symmetry descriptor 856, the sample frame orientation may be determined relative to the expected reference frame. FIG. 9 is an embodiment of a series of rotations for automatic texture alignment of crystallographic orientations smoothed by a SHT 946 in a sample frame with a reference frame of a known texture based on the composite symmetry alignment, such as described in relation to FIG. 8.

In some embodiments, the dataset including the crystallographic orientations is compared to the target spherical function to derive the needed rotation. In some embodiments, the composite symmetry descriptor 954 has at least three peak illustrative intensities 958-1, 958-2, 958-3 that are identified and are shown rotated as the dataset is transformed to align the peak intensities of a target symmetry descriptor (such as the target symmetry descriptor 856 described in relation to FIG. 8). The rotations applied to the composite symmetry descriptor 954 to align the peak intensities 958-1, 958-2, 958-3 with those of the target symmetry descriptor can be applied to the crystallographic orientations of the PF smoothed by the SHT 946 to rotate and align the dataset (collected in the sample frame) with an expected reference frame associated with a conventional texture analysis.

For example, the second composite symmetry descriptor 954 in the bottom row illustrates a rotation of the composite symmetry descriptor 954 to maximize the correspondence of the entire PF image with the target function 856 (which is shown as aligning the three illustrative peak intensities 958-1, 958-2, 958-3) such that the composite symmetry descriptor 954 maximizes the orthorhombic symmetry (2/m2/m2/m point group) exhibiting three mutually-orthogonal mirror planes and three mutually-orthogonal twofold rotation axes. While this orientation of the composite symmetry descriptor 954 maximizes the orthorhombic symmetry, in some embodiments, a different alignment and associated rotations of the dataset of crystallographic orientations is selected to minimize the rotation from the original sample frame. For example, the second composite symmetry descriptor 954 (that maximizes the exhibited orthorhombic symmetry) is achieved by a −157° rotation about the [4 4 −1] direction.

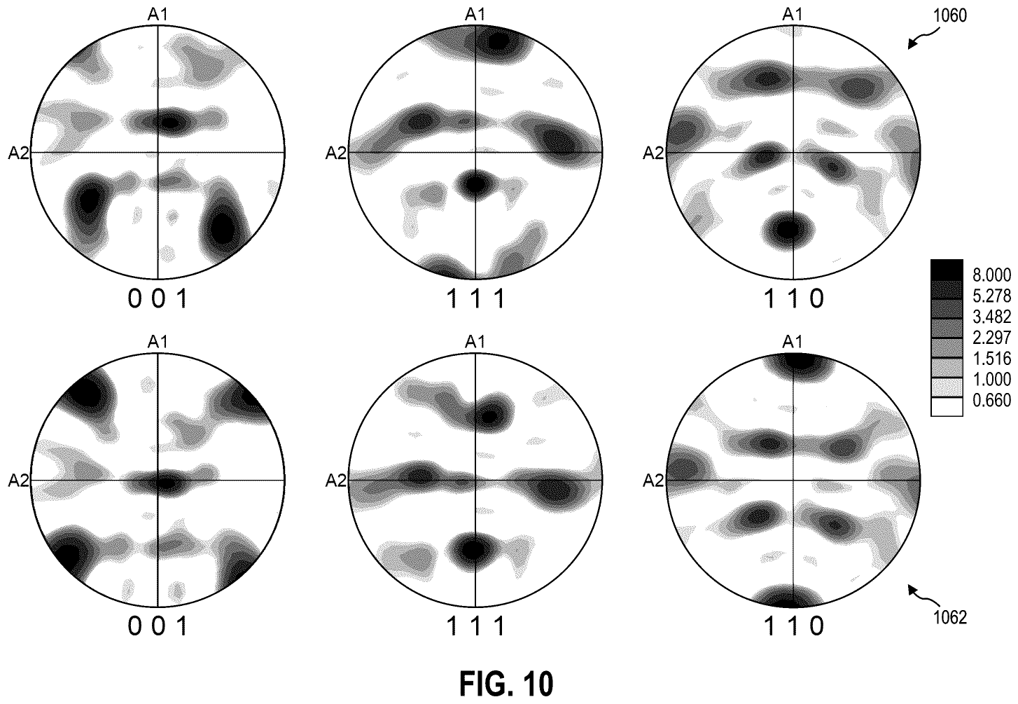

FIG. 10 is an embodiment of a discrete pole figures illustrating automated texture alignment to a reference frame. The left-most PFs illustrate the alignment of the <001> directions of the cubic crystal structure to the reference frame, while the center column of PFs illustrates the <111> directions aligned to the reference frame, and the right-most PFs illustrate the <110> directions aligned to the reference frame. The original sample frame of the smoothed PF 1060 of the top row exhibits a less readily identifiable texture than the same crystallographic orientations of the rotated data PF 1062 of the bottom row.

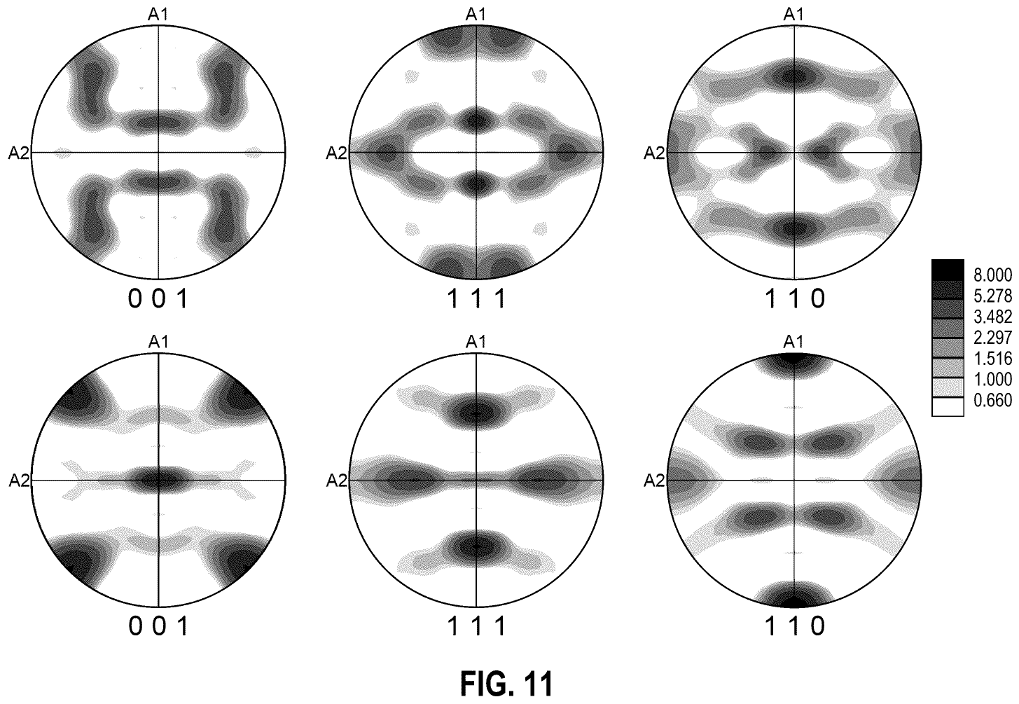

FIG. 11 is an example of enforcing orthorhombic symmetry on the set of crystallographic orientations of FIG. 10. In some embodiments, the strength of the texture increases when symmetry is enforced on the data and/or the dataset is denoised. For example, for orthorhombic symmetry, a measured crystallographic orientation will have an associated orientation present in the orientation space based on the mirror plane and the twofold rotational symmetries. Enforcing symmetry can populate the dataset with additional orientations based on the measured crystallographic orientation from the experimental diffraction patterns described above. In some embodiments, symmetry is enforced on the original discrete crystallographic orientations prior to any binning or smoothing. In some embodiments, symmetry is enforced on a binned dataset of crystallographic orientations prior to smoothing. In some embodiments, symmetry is enforced on a smoothed dataset, such as after a SHT.

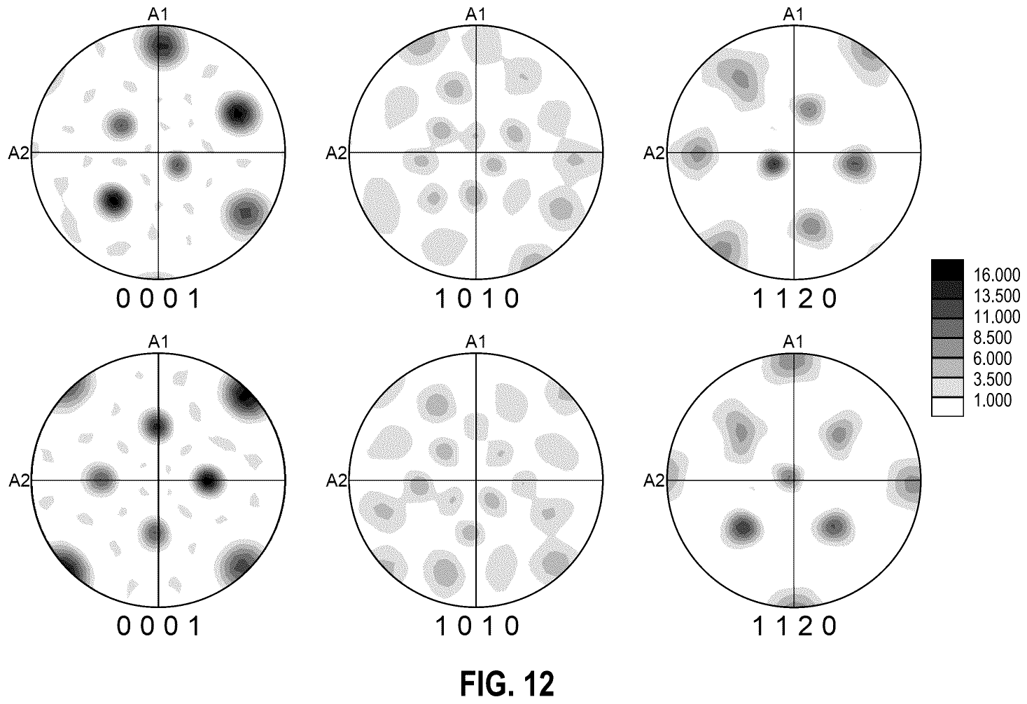

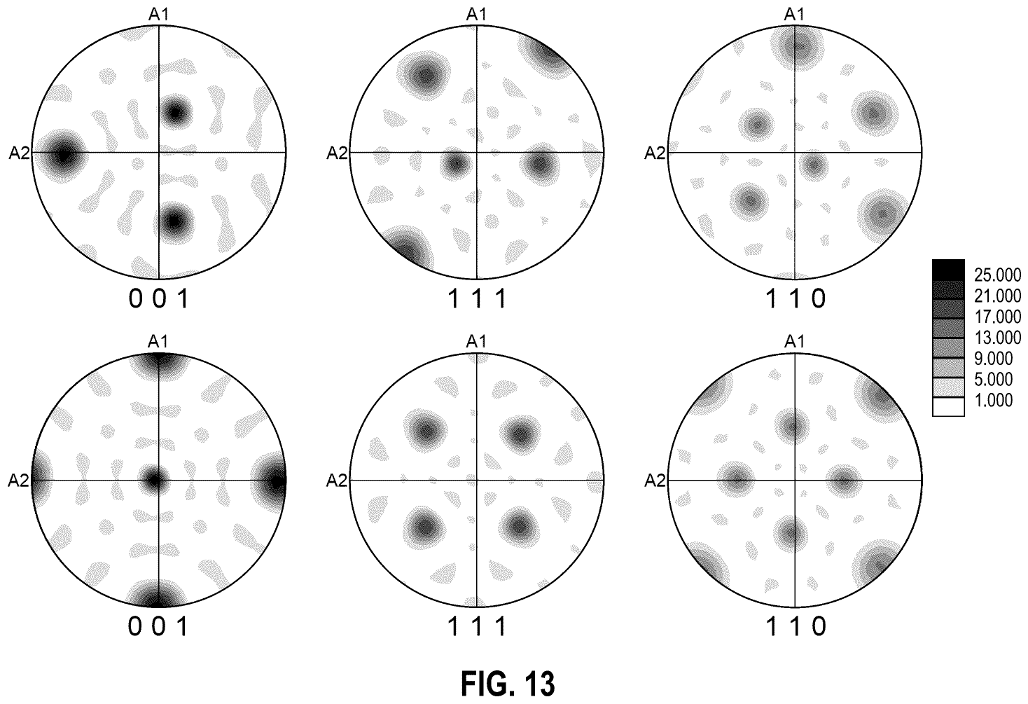

FIG. 12 is an embodiment of PF for a hexagonal titanium sample and the associated automated texture alignment of the PFs. As described in relation to FIG. 8, a target may be calculated based on any known symmetry of the sample material. In some embodiments, systems and methods according to the present disclosure allow for the automated alignment of non-orthorhombic data to an expected texture based on a known or calculated symmetry. For example, the crystallographic orientations illustrated in FIGS. 12 and 13 were obtained from an analysis of additively manufactured (e.g., three-dimensionally printed) titanium alloy. The titanium alloy has, in some embodiments, a hexagonal crystal structure at lower temperatures and a cubic structure at higher temperatures. In some examples, the titanium is deposited during additive manufacturing at an elevated temperature and is, initially, in a cubic crystal structure. As the titanium alloy cools, the cubic crystal structure converts to the stable hexagonal structure.

In some embodiments, the [11-20] texture (i.e., top row) is not immediately recognizable as a parent grain texture (in this instance, an additive manufacturing texture), as the [11-20] texture is related to the conversion of the titanium from a cubic structure at higher temperature to the hexagonal structure that is stable at a lower temperature. For example, the [11-20] direction of the hexagonal structure is associated with the [001] direction of the cubic parent grain structure. FIG. 13 is an embodiment of the parent grain PF for the cubic parent grain of the titanium of FIG. 12 at a high temperature of deposition during additive manufacturing. Through the alignment of the sample frame to the expected reference frame, the association of the [11-20] direction of the hexagonal structure with the [001] direction of the cubic structure aligned with the z-direction of the deposition texture becomes clear.

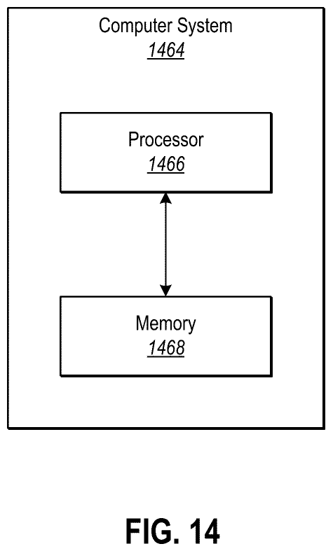

FIG. 14 is a schematic illustration of a computing system 1464 on which any method or portion of a method may be executed. For example, the computing system 1464 may be in data communication with the data collection system 100 described in relation to FIG. 1. In some embodiments, the computing system 1464 is in data communication with the detector 110 and/or the electron microscope described herein. Embodiments described herein may be implemented on various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. As used herein, a “computing system” broadly includes any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

As used herein, the term “executable instructions” or “executable component” can refer to software objects, routings, or methods that may be executed on the computing system. The different components, modules, engines, and services described herein may be implemented as objects or processes that execute on the computing system (e.g., as separate threads).

As illustrated in FIG. 10, a computing system 1464 typically includes at least one processing unit 1466 and memory 1468. The memory 1468 may be physical system memory, which may be volatile, non-volatile, or some combination of the two. The term “memory” may also be used herein to refer to non-volatile mass storage such as physical storage media or other data storage devices. If the computing system is distributed, the processing, memory, and/or storage capability may be distributed as well.

Embodiments of the methods described herein may be described with reference to acts that may be performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 1468 of the computing system 1464. Computing system 1464 may also contain communication channels that allow the computing system 1464 to communicate with other message processors over a wired or wireless network.

Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments described herein can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the functionality disclosed herein.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

In some embodiments, systems and methods for characterizing a material are described herein according to at least the following:

Clause 1. A method for characterizing a material, the method comprising: obtaining a plurality of experimental diffraction patterns; identifying a crystallographic orientation of each diffraction pattern of the plurality of experimental diffraction patterns; building one or more pole figures; selecting a reference spherical function having a reference frame; correlating spherical images from the pole figures and the reference spherical function; determining a sample frame of the crystallographic orientations; and rotating the crystallographic orientations of the plurality of experimental diffraction patterns into alignment with the reference frame to produce a plurality of rotated crystallographic orientations.

Clause 2. The method of clause 1, wherein obtaining the plurality of experimental diffraction patterns includes detecting backscattered electrons from a sample in a scanning electron microscope.

Clause 3. The method of clause 1, wherein obtaining the plurality of experimental diffraction patterns includes detecting diffracted electrons from a sample in an transmission electron microscope.

Clause 4. The method of clause 1, further comprising determining a rotated texture intensity of the plurality of rotated crystallographic orientations.

Clause 5. The method of clause 1, wherein rotating the crystallographic orientations includes determining an angular difference between the reference spherical function and the plurality of rotated crystallographic orientations via spherical harmonic indexing.

Clause 6. The method of clause 1, further comprising binning the crystallographic orientations prior to determining the correlating the spherical images.

Clause 7. The method of clause 6, wherein the crystallographic orientations are binned in an equal area grid.

Clause 8. The method of clause 7, wherein the equal area grid is a square Lambert binning grid.

Clause 9. The method of clause 1, wherein determining a sample frame includes comparing a texture measurement of the pole figures to a reference texture of the reference spherical function.

Clause 10. The method of clause 1, wherein rotating the crystallographic orientations of the plurality of experimental diffraction patterns into alignment with the reference frame includes determining a rotational axis direction and a rotational angle.

Clause 11. A method of characterizing a material, the method comprising: obtaining a plurality of experimental diffraction patterns; identifying a crystallographic orientation of each diffraction pattern of the plurality of experimental diffraction patterns; building one or more pole figures; determining symmetry group of the plurality of experimental diffraction patterns; selecting a reference spherical function having a reference frame based at least partially on the symmetry group; correlating spherical images from the pole figures and the reference spherical function; determining a sample frame of the crystallographic orientations relative to the reference frame; and rotating the crystallographic orientations of the plurality of experimental diffraction patterns into alignment with the reference frame to produce a plurality of rotated crystallographic orientations.

Clause 12. The method of clause 11, further comprising determining a symmetry descriptor for each primary direction of the experimental diffraction patterns.

Clause 13. The method of clause 12, further comprising creating a composite symmetry descriptor with a weighted sum of the symmetry descriptor for each primary direction of a crystal structure of the material.

Clause 14. The method of clause 12, further comprising calculating a target symmetry descriptor in accordance with a known symmetry group.

Clause 15. The method of clause 11, further comprising enforcing symmetry on the crystallographic orientations.

Clause 16. The method of clause 11, wherein symmetry is enforced after smoothing a dataset of the crystallographic orientations.

Clause 17. The method of clause 16, wherein the symmetry is an orthorhombic symmetry based at least partially on a processing of the sample.

Clause 18. A system for characterizing a material, the system comprising: an electron microscope including an electron source configured to produce electrons; a detector configured to receive diffracted electrons produced by the electron source; and a computing system in data communication with the detector, the computing system including: a processor, and memory having instructions stored thereon that, when executed by the processor, cause the computing system to: obtain a plurality of experimental diffraction patterns, identify a crystallographic orientation of each diffraction pattern of the plurality of experimental diffraction patterns, build one or more pole figures; select a reference spherical function having a reference frame; correlate spherical images from the pole figures and the reference spherical function; determine a sample frame of the crystallographic orientations, and rotate the crystallographic orientations of the plurality of experimental diffraction patterns into alignment with the reference frame to produce a plurality of rotated crystallographic orientations.

Clause 19. The system of clause 18, wherein the electron microscope is a scanning electron microscope.

Clause 20. The system of clause 18, wherein the electron microscope is a transmission electron microscope.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. Any element of an embodiment described herein may be combined with any element of any other embodiment described herein. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for characterizing a material, the method comprising:
obtaining a plurality of experimental diffraction patterns;
identifying a crystallographic orientation of each diffraction pattern of the plurality of experimental diffraction patterns;
building one or more pole figures;
selecting a reference spherical function having a reference frame;
correlating spherical images from the pole figures and the reference spherical function;
determining a sample frame of the crystallographic orientations; and
rotating the crystallographic orientations of the plurality of experimental diffraction patterns into alignment with the reference frame to produce a plurality of rotated crystallographic orientations.

2. The method of claim 1, wherein obtaining the plurality of experimental diffraction patterns includes detecting backscattered electrons from a sample in a scanning electron microscope.

3. The method of claim 1, wherein obtaining the plurality of experimental diffraction patterns includes detecting diffracted electrons from a sample in an transmission electron microscope.

4. The method of claim 1, further comprising determining a rotated texture intensity of the plurality of rotated crystallographic orientations.

5. The method of claim 1, wherein rotating the crystallographic orientations includes determining an angular difference between the reference spherical function and the plurality of rotated crystallographic orientations via spherical harmonic indexing.

6. The method of claim 1, further comprising binning the crystallographic orientations prior to determining the correlating the spherical images.

7. The method of claim 6, wherein the crystallographic orientations are binned in an equal area grid.

8. The method of claim 7, wherein the equal area grid is a square Lambert binning grid.

9. The method of claim 1, wherein determining a sample frame includes comparing a texture measurement of the pole figures to a reference texture of the reference spherical function.

10. The method of claim 1, wherein rotating the crystallographic orientations of the plurality of experimental diffraction patterns into alignment with the reference frame includes determining a rotational axis direction and a rotational angle.

11. A method of characterizing a material, the method comprising:
obtaining a plurality of experimental diffraction patterns;
identifying a crystallographic orientation of each diffraction pattern of the plurality of experimental diffraction patterns;
building one or more pole figures;
determining symmetry group of the plurality of experimental diffraction patterns;
selecting a reference spherical function having a reference frame based at least partially on the symmetry group;
correlating spherical images from the pole figures and the reference spherical function;
determining a sample frame of the crystallographic orientations relative to the reference frame; and
rotating the crystallographic orientations of the plurality of experimental diffraction patterns into alignment with the reference frame to produce a plurality of rotated crystallographic orientations.

12. The method of claim 11, further comprising determining a symmetry descriptor for each primary direction of the experimental diffraction patterns.

13. The method of claim 12, further comprising creating a composite symmetry descriptor with a weighted sum of the symmetry descriptor for each primary direction of a crystal structure of the material.

14. The method of claim 12, further comprising calculating a target symmetry descriptor in accordance with a known symmetry group.

15. The method of claim 11, further comprising enforcing symmetry on the crystallographic orientations.

16. The method of claim 11, wherein symmetry is enforced after smoothing a dataset of the crystallographic orientations.

17. The method of claim 16, wherein the symmetry is an orthorhombic symmetry based at least partially on a processing of the sample.

18. A system for characterizing a material, the system comprising:
an electron microscope including an electron source configured to produce electrons;
a detector configured to receive diffracted electrons produced by the electron source; and
a computing system in data communication with the detector, the computing system including:
a processor, and
memory having instructions stored thereon that, when executed by the processor, cause the computing system to:
obtain a plurality of experimental diffraction patterns,
identify a crystallographic orientation of each diffraction pattern of the plurality of experimental diffraction patterns,
build one or more pole figures;
select a reference spherical function having a reference frame;
correlate spherical images from the pole figures and the reference spherical function;
determine a sample frame of the crystallographic orientations, and
rotate the crystallographic orientations of the plurality of experimental diffraction patterns into alignment with the reference frame to produce a plurality of rotated crystallographic orientations.

19. The system of claim 18, wherein the electron microscope is a scanning electron microscope.

20. The system of claim 18, wherein the electron microscope is a transmission electron microscope.
